(19) United States
(12) Patent Application Publication
(10) Pub. No.: US 2023/0094233 A1
(43) Pub. Date: Mar. 30, 2023

(54) MOBILE DEVICE SLED

(71) Applicant: MOVE FAST, LLC, Chicago, IL (US)

(72) Inventors: Jan Marcel Daniel BLANCHARD, Southlake, TX (US); Dominic John SOUTHGATE, Naas (IE)

(21) Appl. No.: 17/955,441

(22) Filed: Sep. 28, 2022

Related U.S. Application Data
(60) Provisional application No. 63/249,343, filed on Sep. 28, 2021.

(51) Int. Cl. H04B 1/3883; H04B 1/3888; H04M 1/04; H04M 1/72409

(52) U.S. Cl. CPC H04B 1/3883; H04B 1/3888; H04M 1/04; H04M 1/724092; H04M 2201/08

(57) ABSTRACT

The present disclosure relates to a sled attachable to a mobile device. The sled comprises a chargeable protective case, an externally powered device such as a mobile payment device, and one or more batteries.

### CROSS-REFERENCE TO RELATED APPLICATIONS

This application claims priority to U.S. Provisional Patent Application Ser. No. 63/249,343, filed on Sep. 28, 2021, titled “MOBILE DEVICE SLED,” the entirety of which is incorporated by reference.

### TECHNICAL FIELD

The present disclosure generally relates to a mobile device payment system.

### BACKGROUND

Mobile devices, such as smart phones and tablet devices, are capable of being used with payment devices. More particularly, the mobile device can connect and communicate with (e.g., physically or wirelessly) a payment device, such as a mobile card reader, to enable the mobile device (e.g., via an application executing thereon) to receive and process transactions using various means of payment, such as credit cards and electronic wallets. Over a period of use with the payment device, the mobile device battery life gradually depletes. This causes an issue in environments that require prolonged use of the mobile device and payment device combination, such as on flights (whether long-haul or sequential throughout the day).

Additionally, mobile devices can be used with other detachable devices, including scanners. Scanners, like payment devices, gradually deplete the battery of the mobile device over prolonged use. Further, mobile devices require regular charging, either through the use of an external battery pack or through connection to a conventional electrical system. This creates a problem in areas where power connections are not readily available.

### SUMMARY

Embodiments presented herein disclose a sled attachable to a mobile device. The sled comprises a chargeable protective case, an externally powered device such as a mobile payment device, and one or more batteries.

The attachable sled may comprise a chargeable case for supplying electrical charge to a mobile device, an external battery magnetically attachable to the chargeable case, and an external device magnetically attachable to the external battery. In some embodiments, the chargeable case, the external battery, and the external device form a magnetic fixation system for providing a collective charge to the mobile device, external device, and chargeable case. In some embodiments, the external device magnetically attachable to the battery is a payment device. Additionally, in an example embodiment, the mobile device, payment device, and chargeable case are communicatively coupled via near-field communication, Bluetooth, or a hardwired data connection.

The chargeable case further may comprise a power management system for distributing the collective charge to the mobile device, external device, and chargeable case. In an example embodiment, the power management system comprises a load balancing system configured to charge the mobile device, external device, and chargeable case at different rates. The chargeable case further comprises a charging port configured to provide electrical charge to the mobile device, external device, and external battery. Additionally, in an example embodiment, the chargeable case further comprises a strap, ring, or other coupling mechanism configured to support the chargeable case. In some embodiments, the external battery further comprises an external battery having an output of about 1 amp to about 3.5 amps.

### BRIEF DESCRIPTION OF THE DRAWINGS

FIG. 1 shows a perspective view of a first embodiment of a sled attachable to a mobile device.

FIG. 2 shows a front view of the sled attachable to a mobile device of FIG. 1.

FIG. 3 shows a rear view of the sled attachable to a mobile device of FIG. 1.

FIG. 4 shows a right side view of the sled attachable to a mobile device of FIG. 1.

FIG. 5 shows a left side view of the sled attachable to a mobile device of FIG. 1.

FIG. 6 shows a top view of the sled attachable to a mobile device of FIG. 1.

FIG. 7 shows a bottom view of the sled attachable to a mobile device of FIG. 1.

FIG. 8 shows a perspective view of the first embodiment of the sled attachable to a mobile device of FIG. 1 with the payment device omitted.

FIG. 9 shows a front view of the sled attachable to a mobile device of FIG. 8.

FIG. 10 shows a rear view of the sled attachable to a mobile device of FIG. 8.

FIG. 11 shows a right side view of the sled attachable to a mobile device of FIG. 8.

FIG. 12 shows a left side view of the sled attachable to a mobile device of FIG. 8.

FIG. 13 shows a top view of the sled attachable to a mobile device of FIG. 8.

FIG. 14 shows a bottom view of the sled attachable to a mobile device of FIG. 8.

FIG. 15 shows a perspective view of the first embodiment of the sled attachable to a mobile device of FIG. 1 with the components exploded.

FIG. 16 shows a right side view of the exploded view of the sled attachable to a mobile device of FIG. 15.

FIG. 17 shows a left side view of the exploded view of the sled attachable to a mobile device of FIG. 15.

FIG. 18 shows a top view of the exploded view of the sled attachable to a mobile device of FIG. 15.

FIG. 19 shows a bottom view of the exploded view of the sled attachable to a mobile device of FIG. 15.

FIG. 20 shows a perspective view of a second embodiment of the sled attachable to a mobile device.

FIG. 21 shows a perspective view of the second embodiment of the sled attachable to a mobile device of FIG. 20.

### DETAILED DESCRIPTION

Embodiments presented herein disclose a payment sled for a mobile device. More particularly, the payment sled is an apparatus comprising several components, which may include a case enclosing at least a portion of the mobile device, an external device such as a payment device, and one or more batteries. The case is capable of providing charge to the mobile device and other components of the payment sled. To do so, as further described herein, each of the mobile device, payment device, and batteries incorporates magnetic components to form a magnetic fixation system. Advantageously, the structure of the magnetic fixation system and the arrangement of the payment sled components provides a “pass-through” mechanism to provide collective charging of the mobile device and payment device. As a result, the payment sled may extend a battery life of the mobile device and payment device to allow for extended use in a variety of settings, such as flights (e.g., long-haul flights, sequential flights), charity events, mobile food services, and so on.

The following detailed description includes references to the accompanying figures. In the figures, similar symbols typically identify similar components, unless context dictates otherwise. The example embodiments described herein are not meant to be limiting. Other embodiments may be utilized, and other changes may be made, without departing from the scope of the subject matter presented herein. It will be readily understood that the aspects of the present disclosure, as generally described herein and illustrated in the figures can be arranged, substituted, combined, separated, and designed in a wide variety of different configurations, all of which are contemplated herein.

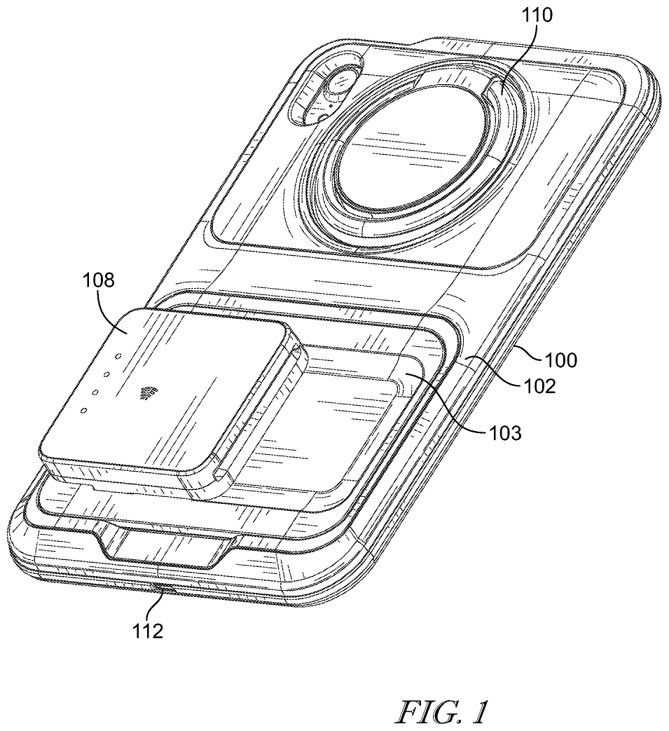

FIG. 1 illustrates an example embodiment of a payment sled attachable to a mobile device. In particular, FIG. 1 depicts a mobile device 100 encased within a chargeable case 102 of the payment sled. FIG. 1 further shows a modular component 103 coupled to the chargeable case 102 that allows the payment device 108 to be coupled to the chargeable case 102. The modular component 103 allows any number of additional components to be coupled to the chargeable case, including, but not limited to, batteries, scanning devices, and printing devices.

Turning ahead to FIG. 20, the chargeable case 102 containing the mobile device 100 is shown coupled to an external battery 202 and a payment device 108. FIG. 20 further shows an external charger 502 which can be connected via a charging cable 702 to the external battery 202 to provide a charge to the external battery 202. The external charger 502 may comprise USB ports 506, Lighting ports 505, or any other suitable charging port to provide a charge to the external battery 202. The external battery 202 may be of numerous different sizes, including, but not limited to, a battery ranging from 1 amp to 3.5 amps in power. In some embodiments, the payment device 108 may comprise a scanner (not shown). The scanner (not shown) is attached to the chargeable case 102 via the modular component 103. It is advantageous to present design that the payment device 108 may be any number of external devices such as a scanner for use in warehousing solutions. The scanner would magnetically attach to the same location as the payment device 108. Additionally, a printer (not shown) can be attached to the device via the modular component 103 such that cordless printing from the mobile device 100 can be achieved. This gives the present design the ability to be customized for independent customer needs while still retaining the modular base components of the chargeable case 102 and the modular component 103.

The chargeable case 102, in an example embodiment, further comprises a ring 110. The ring 110 allows a user to hold the payment sled with one hand, leaving the other hand free to use the mobile device 100. It is understood that this design is not limited to rings and may also consist of straps or any similar handle-type mechanism. The ring 110 further may be extended and used to support the mobile device 100 on a flat surface. The chargeable case 102 further comprises a charging port 112. The charging port 112 allows the mobile device 100, chargeable case 102, and payment device 108 to be charged via a connection to an external power source, such as a wall socket.

FIG. 1 further shows the connection between the payment device 108, the modular component 103, and the chargeable case 102. The payment device 108 is magnetically coupled to the modular component 103. The modular component 103 is further magnetically coupled to the chargeable case 102. The modular component 103, in some embodiments, allows data and power to pass through between the payment device 108 or other component such as an external battery 202, printer (not shown), or scanner (not shown), and the chargeable case 102.

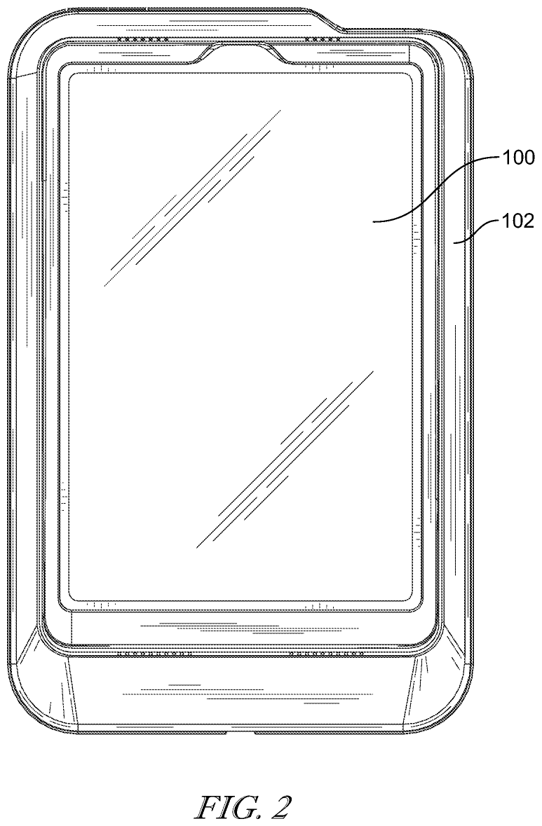

FIG. 2 depicts a front facing view of the mobile device 100 encased within the chargeable case 102 of the payment sled. The mobile device 100 may be a smartphone device (e.g., an ANDROID or IOS based mobile phone, tablet, or miniature tablet) on which software applications may be installed and executed. An added benefit of the example embodiment is that the chargeable case 102 may comprise silicone, rubber, or any other shock absorbing material to protect and insulate the mobile device 100 from bumps and drops. Additionally, in the example embodiment, the mobile device 100 connects to the chargeable case 102 via a port (not shown, encased within the chargeable case) in the bottom of the mobile device 100. Additionally, the chargeable case 102 may provide a seal to allow for weatherproofing of the mobile device 100.

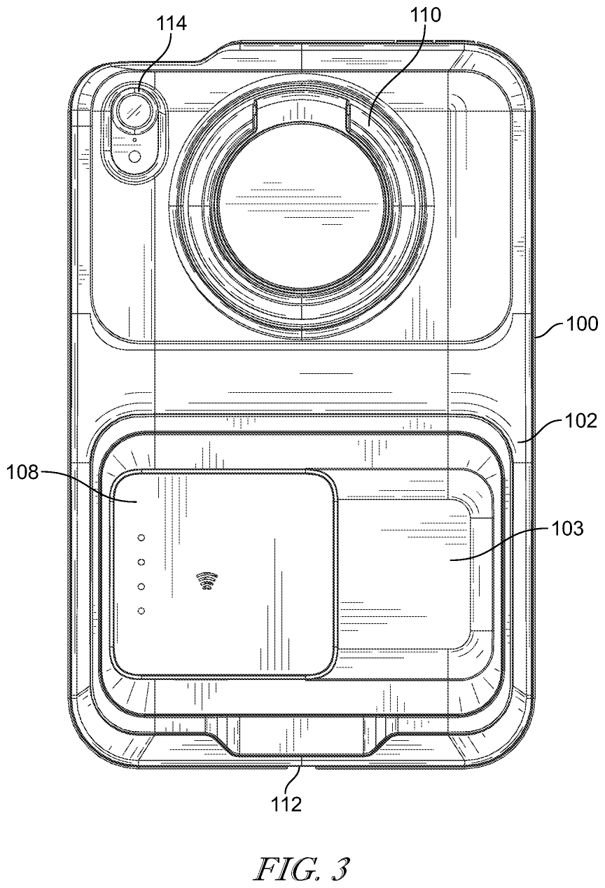

FIG. 3 shows the modular component 103 in additional detail. The modular component 103 allows for any number of additional components to be attached to the chargeable case 102. One such component is an external battery 202 (shown in FIG. 20) which may be a rechargeable lithium ion battery that enables the chargeable case 102 to provide a charge to and thereby extend the battery life of the mobile device 100. The external battery 202 may be recharged via inductive charging or via a hardwired connection to a power source. The chargeable case 102 may cover a portion of the mobile device 100 while leaving other portions exposed, such as a camera 114, cable port 112, display (not shown), and so on. Further, the chargeable case 102 may provide a magnetic insert slot on the bottom rear thereof on which the payment device 108 and the modular component 103 may magnetically attach, e.g., using spring connectors. By this attachment, the chargeable case 102 provides an inductive power source through currents generated by magnetic fields to charging circuits of other payment sled components, including the modular component 103 and the payment device 108. In an embodiment, power charging may be toggled on or off by means of a switch (not shown) thereon. Further, the chargeable case 102 may be charged using a variety of methods, such as through a charging cable port 112 to an external power source.

In an example embodiment, the payment device 108 is an electronic reader that may electronically communicate with the mobile device 100 using wired or wireless methods, such as NFC or near-field communication, Bluetooth, WiFi, and the like. The payment device 108 may scan and securely transmit payment data (e.g., obtained from credit cards, electronic wallets, other mobile devices, and the like) to the mobile device 100 for processing by, for example, a point-of-sale application executing on the mobile device 100. Further, the payment device 108 may include a magnetic attachment at the base thereof to enable a magnetic connection with the case 102. The magnetic attachment, when connected with the case 102, may provide a unified charge to the payment device 108.

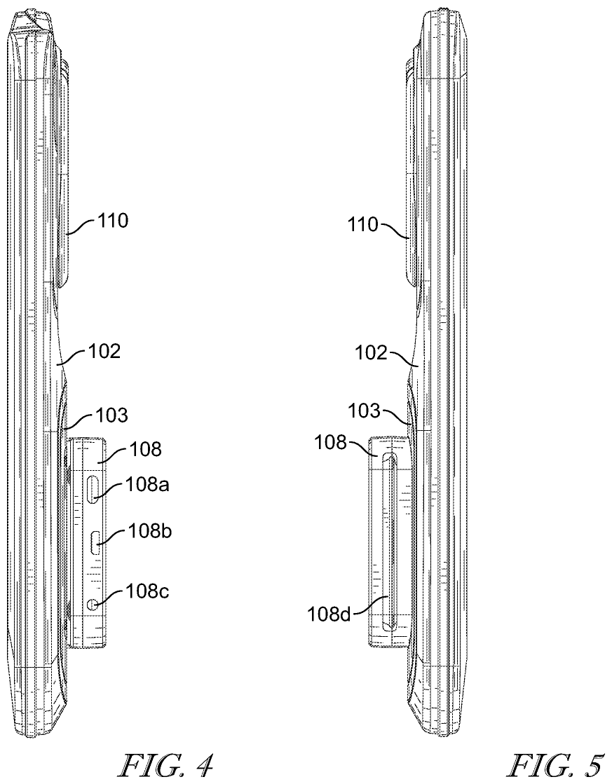

Turning next to FIGS. 4 and 5, the chargeable case 102, modular component 103, and payment device 108 are shown. The payment device 108 further comprises charging ports 108a and 108b to allow the internal battery in the payment device 108 to be charged independently from the chargeable case 102. The payment device also comprises an on/off switch 108c and a slot 108d for reading cards. The payment device 108 is communicatively coupled to the modular component 103 via a magnetic connection which couples it to the chargeable case 102. Any number of additional components can be coupled to the modular component 103 and thereby coupled to the chargeable case 102 such as an external battery 202, printers (not shown), or scanners (not shown).

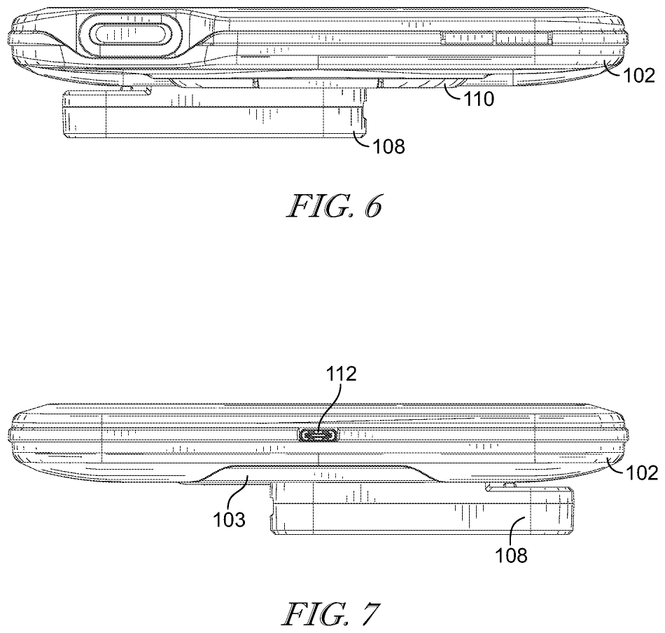

Turning next to FIGS. 6 and 7, the top and bottom of the chargeable case 102, modular component 103, and payment device 108 are shown. The chargeable case 102 and charging port 112 are depicted in relation to one another.

The modular component 103, in some instances, may couple the external battery 202 to the chargeable case 102 to provide additional charge to components in the payment sled, such as after the battery life of the chargeable case 102 has depleted. The modular component 103 and external battery 202 may include a system therein to manage power distribution between the mobile device 100, chargeable case 102, and payment device 108. Further, the modular component 103 may include a magnetic insert that allows the modular component 103 to attach to the insert slot of the case 102 and also enable the payment device 108 to attach atop the modular component 103 as shown.

The magnetic attachments and underlying battery management systems on payment sled collectively form a magnetic fixation system. The magnetic fixation system and the arrangement of components of the payment sled advantageously allows for a smart charging “pass-through” mechanism to simultaneously supply charge to the mobile device 100 and components of the payment sled, such as the payment device 108.

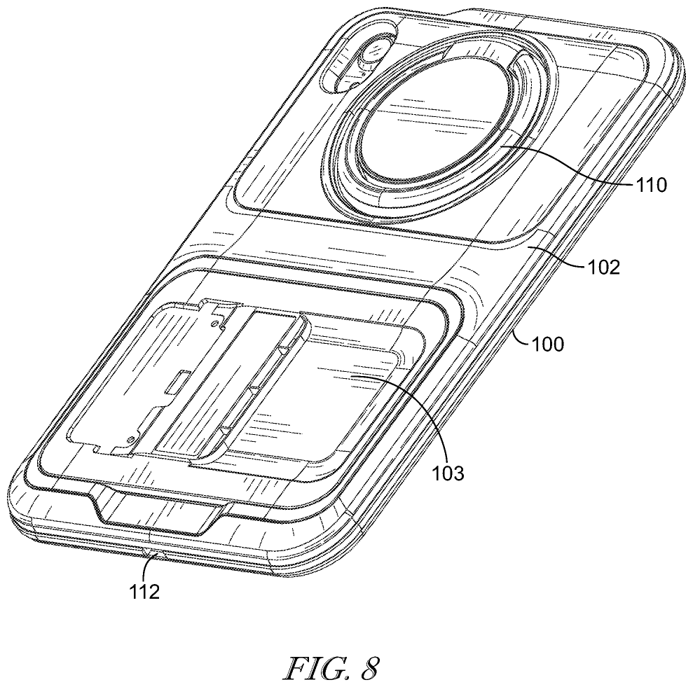

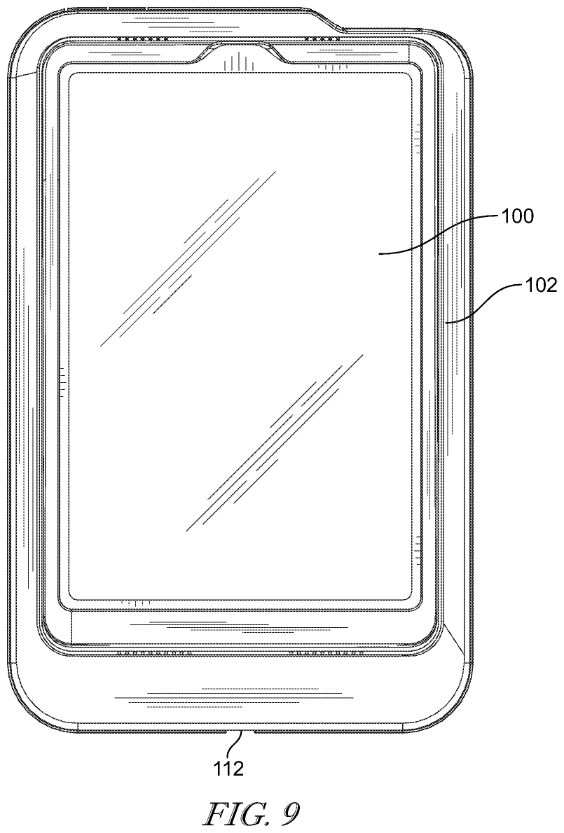

As shown in FIG. 8, an individual may use the payment sled in different configurations, such as with or without the payment device 108 attached. Without the payment device 108 attached, the modular component 103 and chargeable case 102 provide battery power to the mobile device 100. The modular component 103 also allows for different components such as an external battery 202, printers (not shown), or scanners (not shown), to be attached to the chargeable case 102.

In addition, the payment sled is adaptable to a variety of mobile device form factors. Various other chargeable case designs may be used to fit a variety of different phone with the same modular component 103 and payment device 108. Advantageously, this granular approach allows for the reuse of payment sled components other than the case, such as the payment device 108 and the modular component 103. This approach allows mobile devices of different form factors (e.g., iterations of a smartphone model, tablet devices, and so on) to leverage the functions provided by the payment sled.

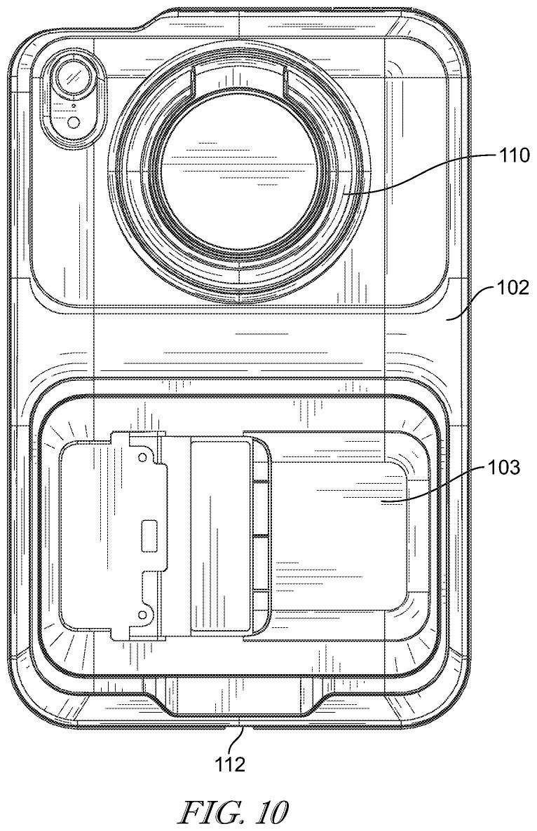

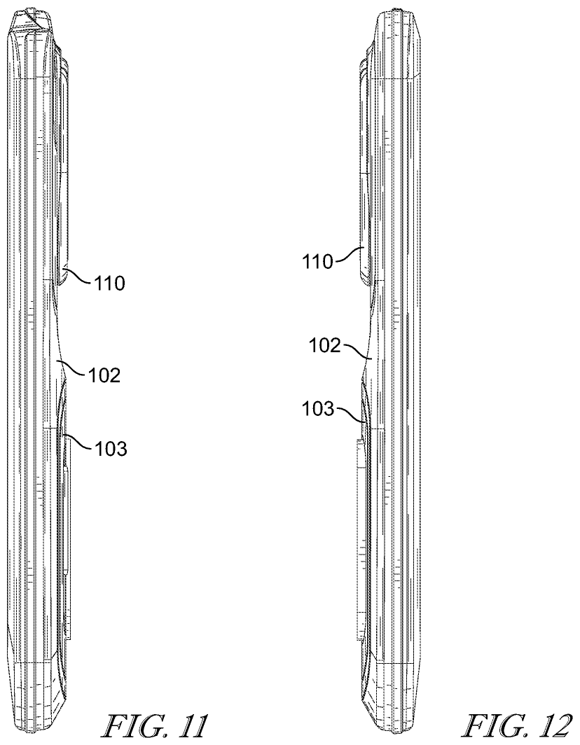

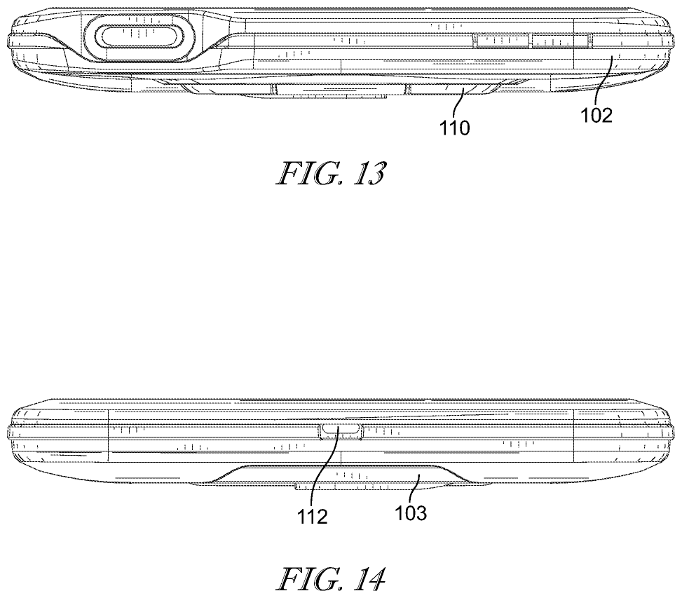

FIGS. 9-14 illustrate example use of the chargeable case 102 without the presence of the payment device 108 or modular component 103. The chargeable case 102, on its own, is configured to provide power to the mobile device 100.

In the example embodiment, assume that a flight attendant user of the mobile device 100 remembers to charge the sled to full power overnight by connection to an external power source. Also assume that the mobile device 100 is also fully charged. In this configuration, the management system in the chargeable case 102 distributes power to charge the mobile device 100 and the chargeable case 102 itself through the internal spring connectors, thereby charging the mobile device 100 and payment sled as like a single unified device.

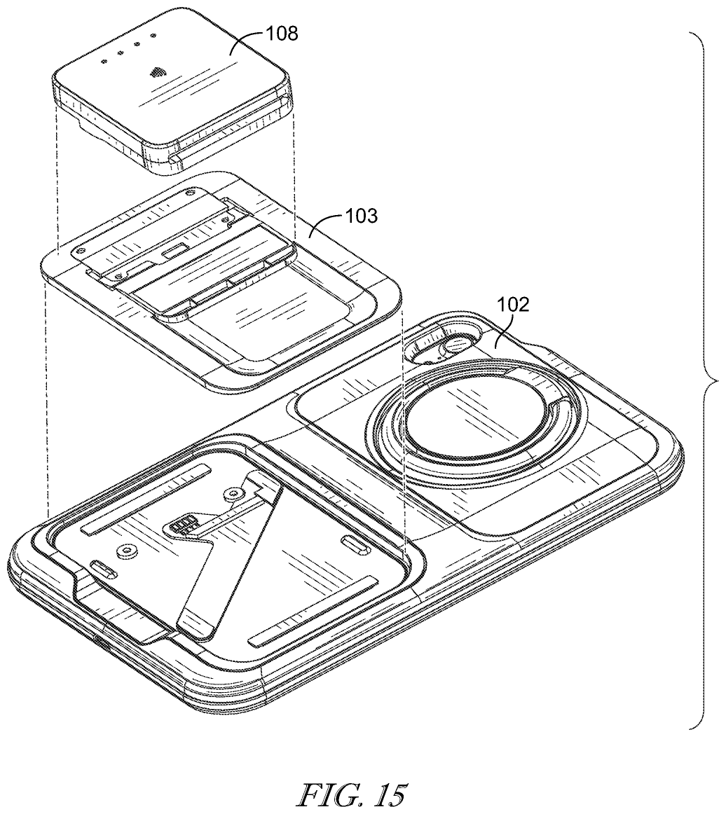

FIG. 15 provides an exploded view of the chargeable case 102, modular component 103, and payment device 108, showing the interconnection of the chargeable case 102, modular component 103, and payment device 108.

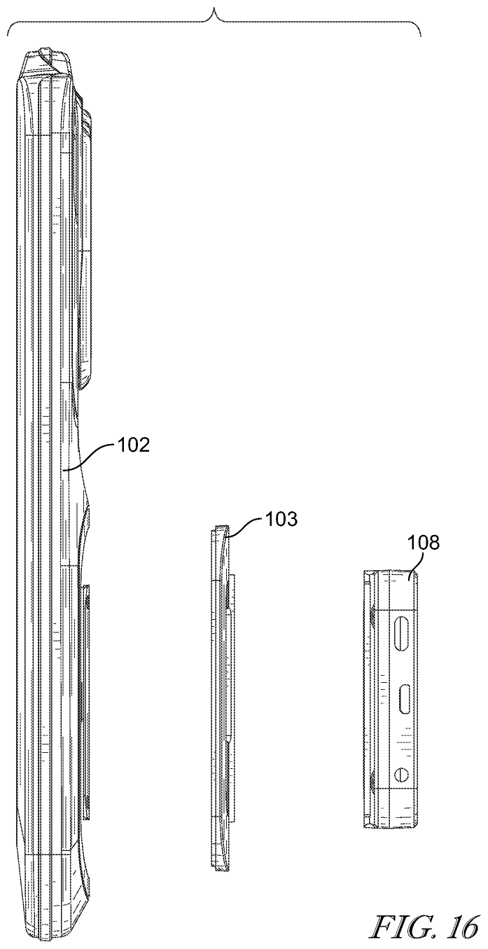

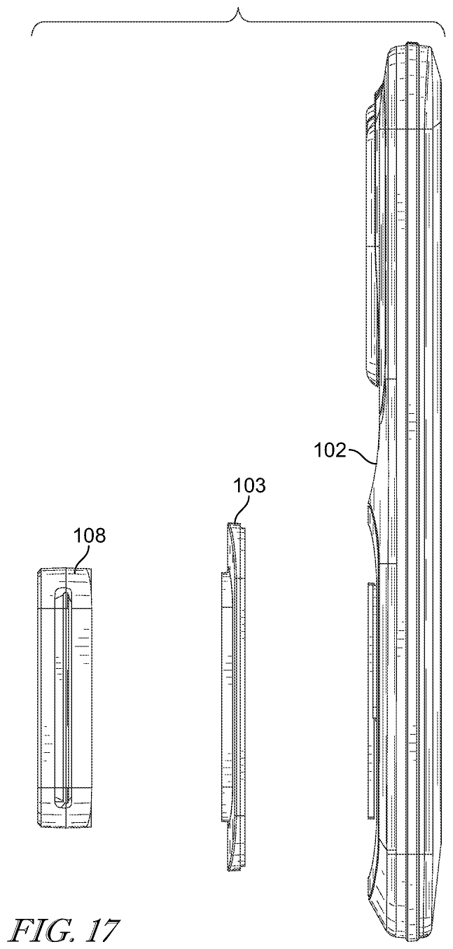

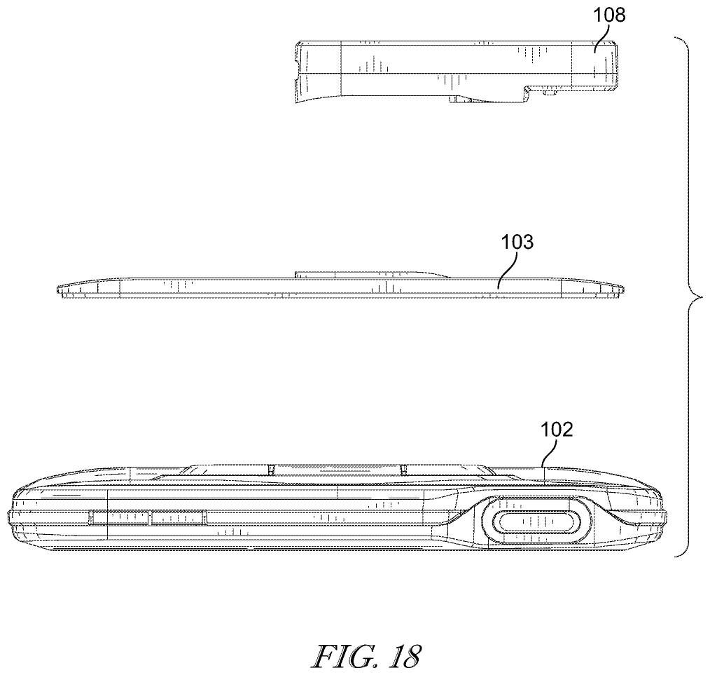

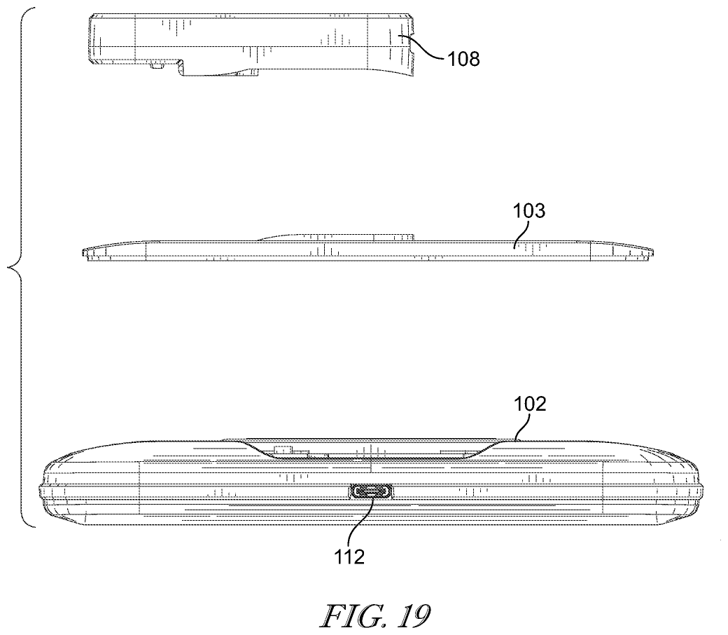

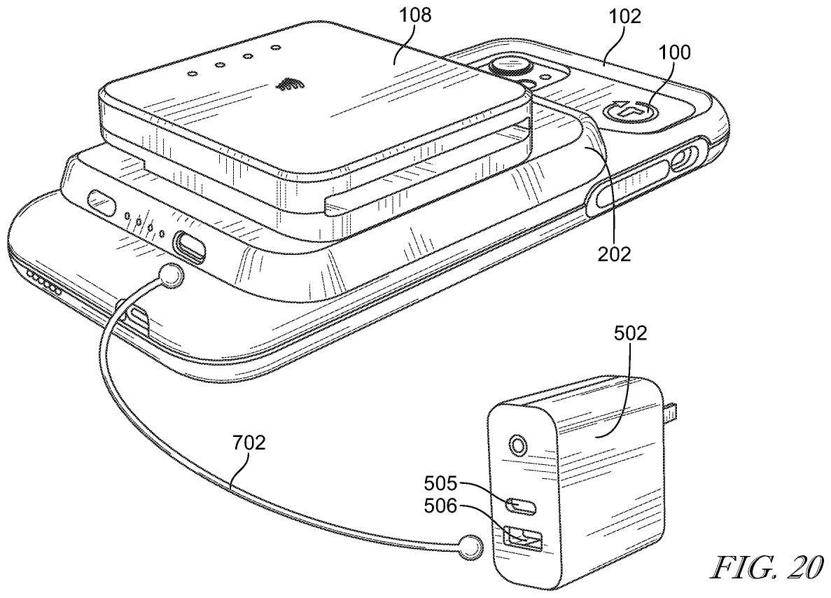

FIGS. 16-19 further illustrate the interconnection of the chargeable case 102, modular component 103, and payment device 108.

In some embodiments, assume that the flight attendant user forgets to charge the payment sled overnight and as a result, the payment sled is only at a partial battery charge (which can be indicated by button and indicator LEDs on the chargeable case 102). Upon attaching the mobile device 100 to the chargeable case 102, the chargeable case 102 may supply charge to the mobile device 100. The power management system of the chargeable case 102 may determine whether the chargeable case 102 needs charge, such as by evaluating threshold battery levels of the chargeable case 102 and the mobile device 100. If the mobile device 100 exceeds a threshold level, the management system may direct the battery to supply some charge to the chargeable case 102 in addition to the mobile device 100, thus providing another instance in which power is supplied to the payment sled components and the mobile device 100 as a single device.

In some embodiments, the chargeable case 102 may be charged via one of the other components such as the external battery 202. In such a case, the mobile device 100 may still receive charge through the pass-through mechanism of the mobile device via the modular component 103, but the charging process may occur more slowly. In such a case, the pass through charging mechanism might not be able to provide charge to the mobile device 100 due to inadequate charge to the case 102.

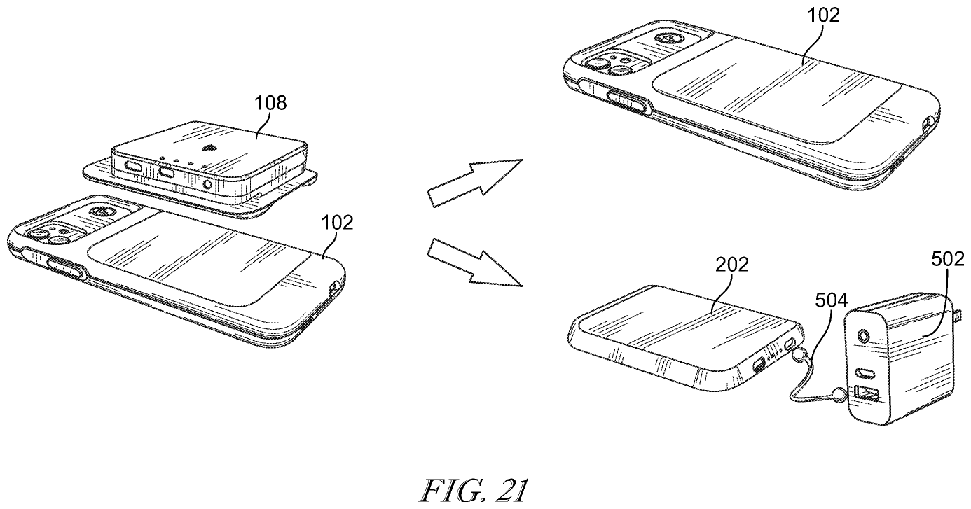

In some embodiments shown in FIG. 21, the mobile device 100 contained within the chargeable case 102 is needed on its own without the payment sled. In such a case, the payment sled components (e.g., chargeable case 102 and external battery 202) can be removed from the sled and charged individually, e.g., via an external charger 502 and charging cable 504 plugged into a power source such as a wall socket. Doing so can ensure a full battery life.

In the foregoing description, numerous specific details, examples, and scenarios are set forth in order to provide a more thorough understanding of the present disclosure. It will be appreciated, however, that embodiments of the disclosure may be practiced without such specific details. Further, such examples and scenarios are provided for illustration only, and are not intended to limit the disclosure in any way. Those of ordinary skill in the art, with the included descriptions, should be able to implement appropriate functionality without undue experimentation.

References in the specification to “an embodiment,” etc., indicate that the embodiment described may include a particular feature, structure, or characteristic. Such phrases are not necessarily referring to the same embodiment. Further, when a particular feature, structure, or characteristic is described in connection with an embodiment, it is believed to be within the knowledge of one skilled in the art to effect such feature, structure, or characteristic in connection with other embodiments whether or not explicitly indicated.

Embodiments in accordance with the disclosure may be implemented in hardware, firmware, software, or any combination thereof. Embodiments may also be implemented as instructions stored using one or more machine-readable media which may be read and executed by one or more processors. A machine-readable medium may include any suitable form of volatile or non-volatile memory.

Modules, data structures, and the like defined herein are defined as such for ease of discussion, and are not intended to imply that any specific implementation details are required. For example, any of the described modules and/or data structures may be combined or divided in sub-modules, sub-processes or other units of computer code or data as may be required by a particular design or implementation of the computing device.

In the drawings, specific arrangements or orderings of elements may be shown for ease of description. However, the specific ordering or arrangement of such elements is not meant to imply that a particular order or sequence of processing, or separation of processes, is required in all embodiments. In general, schematic elements used to represent instruction blocks or modules may be implemented using any suitable form of machine-readable instruction, and each such instruction may be implemented using any suitable programming language, library, application programming interface (API), and/or other software development tools or frameworks. Similarly, schematic elements used to represent data or information may be implemented using any suitable electronic arrangement or data structure. Further, some connections, relationships, or associations between elements may be simplified or not shown in the drawings so as not to obscure the disclosure.

This disclosure is considered to be exemplary and not restrictive. In character, and all changes and modifications that come within the spirit of the disclosure are desired to be protected. While particular aspects and embodiments are disclosed herein, other aspects and embodiments will be apparent to those skilled in the art in view of the foregoing teaching.

While the foregoing is directed to embodiments of the present disclosure, other and further embodiments of the disclosure may be devised without departing from the basic scope thereof, and the scope thereof is determined by the claims that follow.

1. An apparatus comprising:
a chargeable case for supplying electrical charge to a mobile device,
an external battery magnetically attachable to the chargeable case, and
an external device magnetically attachable to the external battery,
wherein the chargeable case, the external battery, and the external device form a magnetic fixation system for providing a collective charge to the mobile device, external device, and chargeable case.

2. The apparatus of claim 1, wherein the chargeable case further comprises an internal battery.

3. The apparatus of claim 1, wherein the chargeable case further comprises a power management system for distributing the collective charge to the mobile device, external device, and chargeable case.

4. The apparatus of claim 3, wherein the power management system further comprises a load balancing system configured to charge the mobile device, external device, and chargeable case.

5. The apparatus of claim 1, wherein the chargeable case further comprises a charging port configured to provide electrical charge to the mobile device, external device, and external battery.

6. The apparatus of claim 1, wherein the external device magnetically attachable to the battery further comprises a payment device or scanner.

7. The apparatus of claim 6, wherein the payment device or scanner further comprises an internal chargeable battery.

8. The apparatus of claim 1, wherein the chargeable case further comprises a coupling mechanism configured to support the chargeable case.

9. The apparatus of claim 1, wherein the mobile device, external device, and chargeable case are communicatively coupled via near-field communication, Bluetooth, WIFI, or a hardwired data connection.

10. The apparatus of claim 1, wherein the external battery further comprises an external battery having an output of about 1 amp to about 3.5 amps.

11. An apparatus comprising:
a chargeable case for supplying electrical charge to a mobile device,
an external battery magnetically attachable to the chargeable case, and
an external device magnetically attachable to the external battery,
wherein the chargeable case, the external battery, and the external device form a magnetic fixation system for providing a collective charge to the mobile device, external device, and chargeable case,
wherein the external device magnetically attachable to the external battery is a payment device.

12. The apparatus of claim 11, wherein the mobile device, payment device, and chargeable case are communicatively coupled via near-field communication, Bluetooth, WIFI, or a hardwired data connection.

13. The apparatus of claim 11, wherein the chargeable case further comprises a power management system for distributing the collective charge to the mobile device, external device, and chargeable case.

14. The apparatus of claim 13, wherein the power management system further comprises a load balancing system configured to charge the mobile device, external device, and chargeable case.

15. The apparatus of claim 11, wherein the external battery further comprises an external battery having an output of about 1 amp to about 3.5 amps.

16. The apparatus of claim 11, wherein the payment device further comprises reversible pins configured to allow the payment device to attach to the external battery in reverse orientation.

17. The apparatus of claim 11, wherein the payment device further comprises an internal chargeable battery.

18. The apparatus of claim 11, wherein the chargeable case further comprises a charging port configured to provide electrical charge to the mobile device, payment device, and external battery.

19. The apparatus of claim 11, wherein the chargeable case further comprises a coupling mechanism configured to support the chargeable case.

20. An apparatus comprising:
a chargeable case for supplying electrical charge to a mobile device,
an external battery magnetically attachable to the chargeable case, and
an external device magnetically attachable to the external battery,
wherein the chargeable case, the external battery, and the external device form a magnetic fixation system for providing a collective charge to the mobile device, external device, and chargeable case,
wherein the external device magnetically attachable to the battery is a payment device,
wherein the mobile device, payment device, and chargeable case are communicatively coupled via near-field communication, Bluetooth, WIFI, or a hardwired data connection,
wherein the chargeable case further comprises a power management system for distributing the collective charge to the mobile device, external device, and chargeable case,
wherein the power management system comprises a load balancing system configured to charge the mobile device, external device, and chargeable case,
wherein the chargeable case further comprises a charging port configured to provide electrical charge to the mobile device, external device, and external battery,
wherein the chargeable case further comprises a coupling mechanism configured to support the chargeable case,
wherein the external battery further comprises an external battery having an output of about 1 amp to about 3.5 amps.
